(19) United States
(12) Patent Application Publication
(10) Pub. No.: US 2003/0097271 A1
(43) Pub. Date: May 22, 2003

(54) Method and system for evaluating synergies between multiple companies or divisions

(76) Inventor: Lawrence E. Rentz, Clifton Park, NY (US)

Correspondence Address: PERKINS COIE LLP, PATENT-SEA, P.O. BOX 1247, SEATTLE, WA, 98111-1247, US

(21) Appl. No.: 09/989,314

(22) Filed: Nov. 20, 2001

(51) Int. Cl. G06F 17/60

(52) U.S. Cl. 705/1

(57) ABSTRACT

A method and system for evaluating synergies between multiple organizations, such as companies or divisions, is provided. In one embodiment, an input component receives information about the assets of an organization from a user on a user computer. The organizational information that is received may be saved in a database. The organization information may include information about an organization's assets, such as facilities, technical capabilities, intellectual property, etc. A search component searches the database for information about a plurality of organizations based on search parameters specified by the user. A synergy evaluation component evaluates the organization information based on inputs from the user and the results of the search. The evaluation may look for similarities between organizations, gaps in the assets of different organizations, etc. A report may be generated summarizing the potential synergies between the organizations.

### BACKGROUND

The described technology relates generally to computer-based synergy evaluation systems and, in particular, to synergy evaluation systems for multiple companies and/or divisions.

The assets of a company can be any of a large variety of tangible and intangible items. For example, a company's assets may include manufacturing facilities, employees, research facilities, resource capabilities, capital equipment, inventories, computers, skills of personnel (e.g., individual capabilities, technical skills or specialties, PhD's, etc.), intellectual property (e.g., trade secret methods, patents, trademarks, etc.), etc. To properly manage a company, it is helpful to know as much information about a company's assets as possible. Without such knowledge, decisions are made in vacuum and a company's assets may not be properly utilized—and potential synergies may never be achieved. For example, a company could hire a computer consultant at a premium price because the Chief Executive Officer (CEO) of that company did not know that such capability already existed within the organization.

The lack of information (and the lack of communication of that information) is exacerbated in situations where a company has multiple divisions. Many companies, particularly large companies, are organized in divisions. For example, a manufacturing company could have a consumer products division, an electronics division, an industrial products division, a consulting services division, etc. Each division may have its own computer systems, databases, organization structures, etc., making communication and the sharing of information increasingly difficult.

The lack of information is even worse in situations where divisions or entire companies are acquired by mergers or acquisitions. The organizations involved in a merger or acquisition may use different computers systems, have different organizational structures, etc. One of the primary reasons to perform a merger or acquisition is to achieve synergies, and goal that can be best achieved by knowing the assets of all parties to the transaction. Without this information, opportunities for synergies or cost savings are not identified and are therefore missed.

It would be desirable to have a synergy evaluation system that would allow company managers to quickly and easily take advantage of synergies between multiple companies and/or divisions.

### BRIEF DESCRIPTION OF THE DRAWINGS

FIG. 1 is a display page illustrating a main display page of the synergy evaluation system in one embodiment.

FIG. 2 is a display page used to collect information from a user about the assets of an organization in one embodiment.

FIG. 3 is a display page used to collect information about the technical capabilities of an organization in one embodiment.

FIG. 4 is a display page used to collect information about the facilities of an organization in one embodiment.

FIG. 5 is a display page used to collect information about the partners of an organization in one embodiment.

FIG. 6 is a display page used to collect information about the certifications of an organization in one embodiment.

FIG. 7 is a display page used to search for information or potential synergies throughout a group of organizations in one embodiment.

FIG. 8 is a display page illustrating the results of a company search in one embodiment.

FIG. 9 is a display page depicting a report summarizing the technical capabilities of an organization in one embodiment.

FIG. 10 is a display page depicting a report summarizing the potential synergies of a newly acquired organization with the existing organizations in one embodiment.

FIG. 11 is a display page depicting a report summarizing the assets of an organization in one embodiment.

FIG. 12 is a block diagram that illustrates components of the synergy evaluation system and user computers in one embodiment.

FIG. 13 is a flow diagram illustrating the input of organizational data by a user in one embodiment.

FIG. 14 is a flow diagram illustrating the receipt of organizational data by the synergy evaluation system in one embodiment.

FIG. 15 is a flow diagram illustrating input of a search request by a user in one embodiment.

FIG. 16 is a flow diagram illustrating the receipt of a search request by the synergy evaluation system in one embodiment.

FIG. 17 is a flow diagram illustrating input of a report request by a user in one embodiment.

FIG. 18 is a flow diagram illustrating the receipt of a report request by the synergy evaluation system in one embodiment.

### DETAILED DESCRIPTION

A method and system for evaluating synergies between multiple organizations, such as companies or divisions, is provided. In one embodiment, an input component receives information about the assets of an organization from a user on a user computer. The organizational information that is received may be saved in a database. The organization information may include information about an organization's assets, such as facilities, technical capabilities, intellectual property, etc. A search component searches the database for information about a plurality of organizations based on search parameters specified by the user. A synergy evaluation component evaluates the organization information based on inputs from the user and the results of the search. The synergy evaluation system may look for similarities between organizations, gaps in the assets of different organizations, etc. A report may be generated summarizing the potential synergies between multiple organizations.

Using this method and system, a user can quickly and efficiently locate synergies between different organizations. For example, a user could search all of the organizations in the synergy evaluation system for a particular facility, such as a testing chamber, and determine if such capability exists within the broad organization, eliminating the need to build one or to rent one from a third party. Similarly, a user could determine where particular capabilities reside witihin the company so that they can be used effectively. In another embodiment, a report may be created when a new company is acquired that summarizes the potential synergies that may exist with other organizations. By including information about organizational assets in the synergy evaluation system, synergies between the organizations can be quickly and easily identified and pursued. Accordingly, additional cost savings may be achieved and the potential advantages of a merger, acquisition or other transaction can be realized.

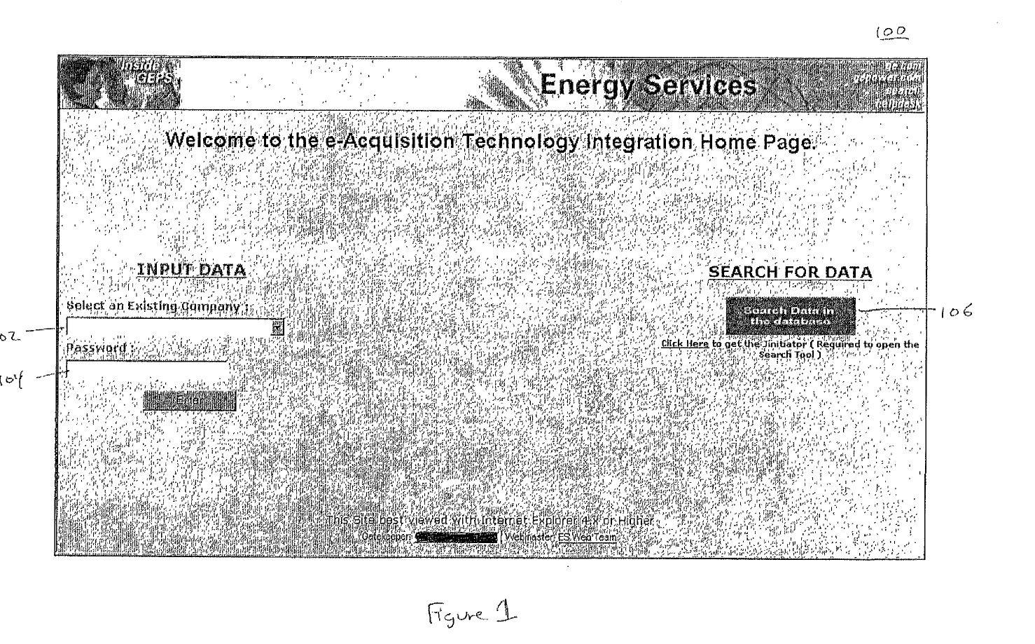

FIGS. 1-11 illustrate sample display pages of a synergy evaluation system in various embodiments. FIG. 1 is a display page illustrating a main display page of the synergy evaluation system in one embodiment. Main display page 100 includes an existing company field 102, a password field 104, and a search button 106. The existing company field is a pull-down list that lets a user select an organization from a list of organizations (e.g., company, division, etc.) for which the user desires to input new organizational data, such as information about the assets of the organization. The password field provides security so that only authorized users may input organizational data. The search button allows users to access the search functionality of the synergy evaluation system.

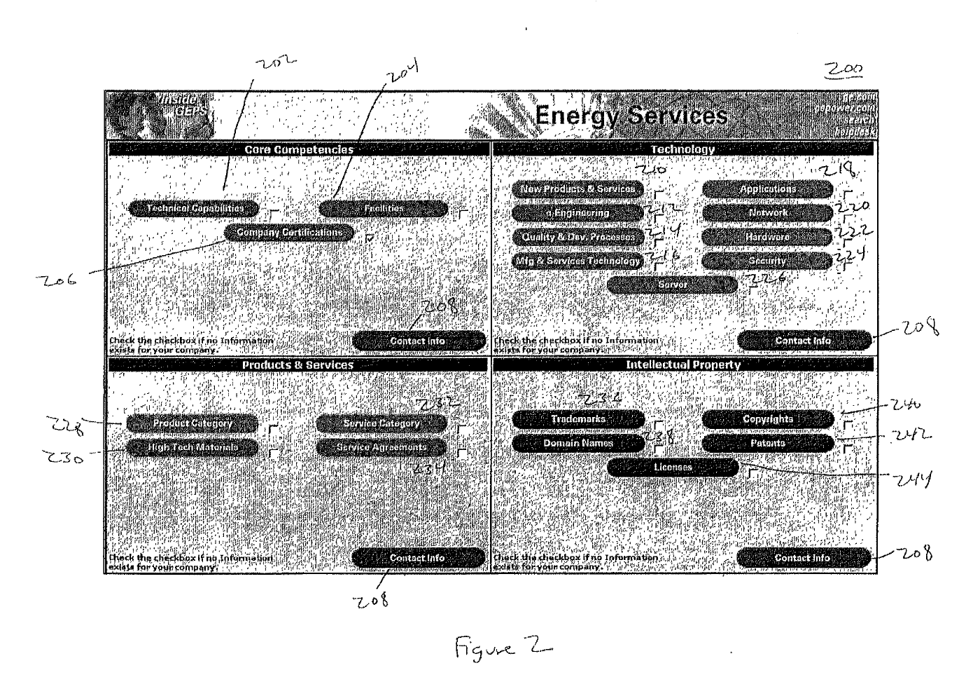

FIG. 2 is a display page used to collect information from a user about the assets of an organization, or other organizational data, in one embodiment. The asset input page 200 allows a user to input a wide variety of information about an organization, including details about the assets of the company. A user may activate the asset input page by selecting an organization and entering a password on the main display page. The asset input page in the depicted embodiment includes four different regions dedicated to core competencies, technology, products & services, and intellectual property. The core competency region includes a technical capabilities button 202, a facilities button 204, a company certifications button 206, and a contact info button 208. The technical capabilities button allows a user to input information about the technical capabilities of an organization, while the facilities button allows a user to input information about an organization's facilities, such as R&D facilities, test facilities, etc. The company certifications button allows a user to input information about the certifications received or achieved by an organization. Each of the buttons that allow a user to input information may include a check box that a user may check if no information need be input for a particular category. The contact info button allows a user to receive information about the contact person at an organization for a particular category of assets and may also provide for changing the contact information by an authorized user.

The technology region of the asset input page (as well as the products & services and intellectual property regions) provides similar functionality to the core competencies region, and various will be described herein. The technology region of the asset input page includes a new products & services button 210, an e-Engineering button 212, a quality processes button 214, a manufacturing & services technology button 216, an applications button 218, a network button 220, a hardware button 222, a security button 224, and a server button 226. Each of these buttons allows a user to input the relevant information about the organization—i.e., the server button allows a user to input information about an organization's server hardware and software, the applications button allows a user information about computer applicants owned or licensed, etc.

Similarly, the products & services region allows users to input information about the products and services offered by a company. The products & services region in the depicted embodiment includes a product category button 228, a high tech materials button 230, a service category button 232, and service agreements button 234. The intellectual property region, on the other hand, includes a trademark button 236, a domain names button 238, a copyrights button 240, a patents button 242, and a licenses button 244. The buttons of the intellectual property region allow a user to input information about an organization's intellectual property portfolio.

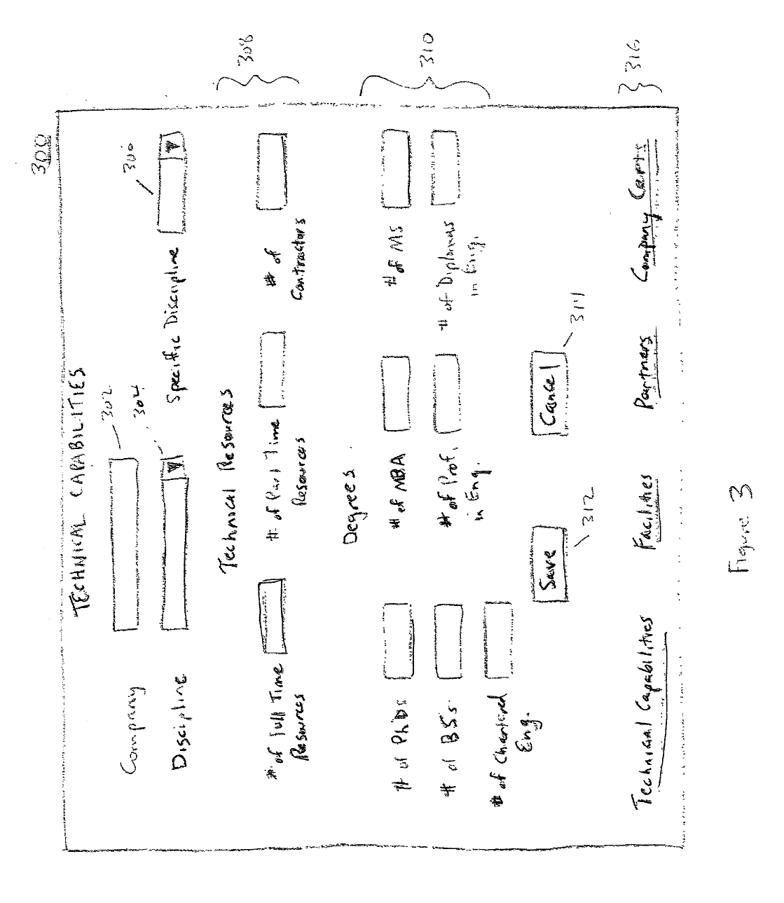

FIG. 3 is a display page used to collect information about the technical capabilities of an organization in one embodiment. Technical capabilities page 300 may be activated when a user selects the technical capabilities button of the asset input page. The technical capabilities page 300 includes, in the depicted embodiment, a company field 302, a discipline field 304, a specific discipline field 306, technical resources fields 308, degree fields 310, a save button 312, a cancel button 314, and technical page selectors 316. The company field allows a user to input the organization for which the user desires to input information. In an alternative embodiment, the company field is a pull down list of available organizations or is automatically populated by the synergy evaluation system based on an organization selected earlier by the user. The discipline field is a pull-down list that allows a user to select a discipline from a list of disciplines in the synergy evaluation system. Sample disciplines could include physics, chemical engineering, electrical engineering, etc. The specific discipline field is a pull-down list that allows a user to select a specific discipline from a list of specific disciplines in the synergy evaluation system, where the specific disciplines may be based on the discipline previously chosen. For example, if chemical engineering was chosen as the discipline, specific disciplines could include emissions, fuels, environmental, organic chemistry, etc.

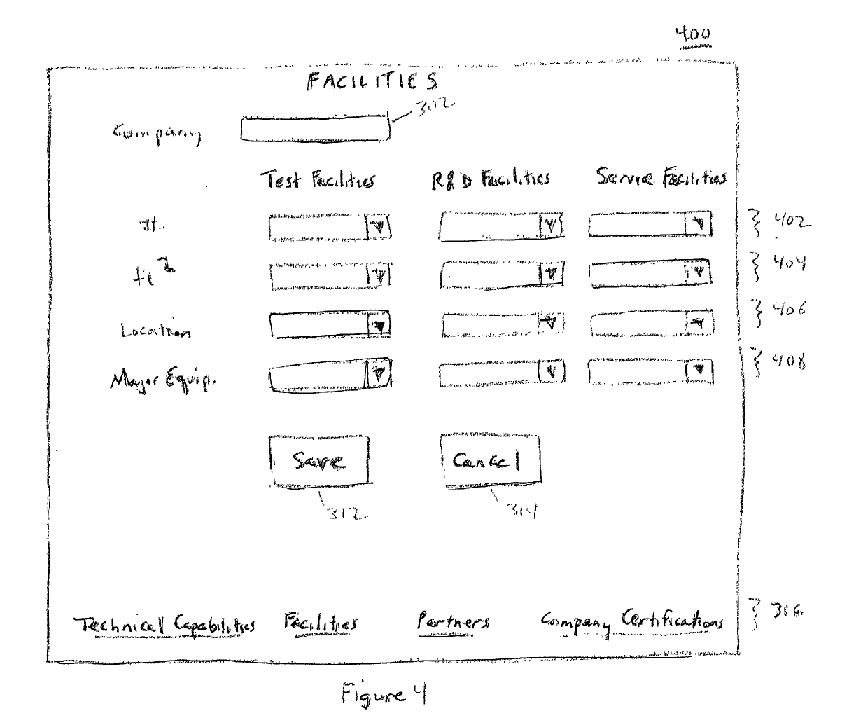

The technical resources fields allow a user to input details about the number of technical employees associated with the organization, such as the number of full time or part time employees, number of contractors, etc. The degrees fields allow a user to input details about the degrees associated with the technical resources or other employees. The degrees fields may include the number of PhD degrees, BS degrees, MS degrees, MBA degrees, Professional Engineers, etc. Both the technical resources fields and the degrees fields may be based on what the user selects for discipline and/or specific discipline. For example, if chemical engineering was selected as the discipline and emissions was selected as the specific discipline, the technical resources fields and the degrees fields would be based on those specialties (e.g., 3 PhD degrees in chemical engineering with specialties in emissions, etc.). The save button of the technical capabilities page will save the information that has been entered by a user, and the cancel button will exit the page without saving any information. The technical page selectors allow a user to select the type of information to be input. The technical capabilities page may be accessed by selecting technical capabilities from the technical page selectors. Other pages may be accessed as well (such as facilities, partners, company certs, etc.) as described below in relation to FIGS. 4-6.

FIG. 4 is a display page used to collect information about the facilities of an organization in one embodiment. Facilities page 400 may be activated when a user selects the facilities button of the asset input page or facilities on the technical page selector. The facilities page 400 includes, in the depicted embodiment, a company field 302, a number field 402, a square footage field 404, a location field 406, a major equipment field 408, a save button 312, a cancel button 314, and technical page selectors 316. The facilities page of FIG. 4 is similar in many ways to the technical capabilities page of FIG. 3 and various differences will be described herein. The number field, square footage field, location field, and major equipment field allow a user to input information about facilities owned or operated by an organization. In the depicted embodiment, a user may input information about test facilities, R&D facilities, or service facilities.

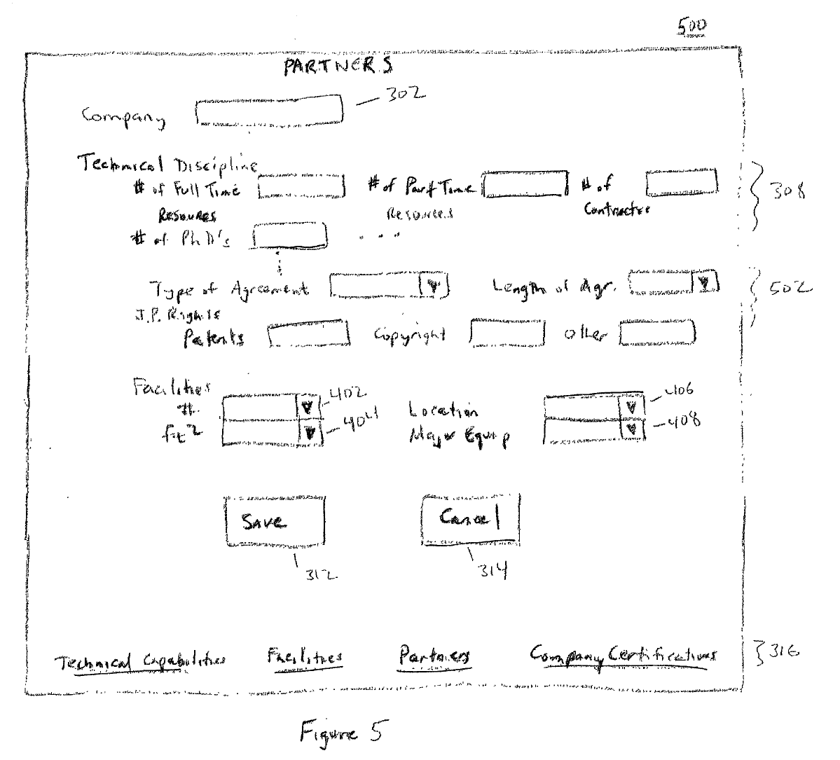

FIG. 5 is a display page used to collect information about the partners of an organization in one embodiment. Partners page 500 may be activated when a user selects the partners button of the asset input page or partners on the technical page selector. The partners page 400 includes, in the depicted embodiment, a company field 302, technical disciplines fields 308, agreement fields 502, a square footage field 404, a location field 406, a major equipment field 408, a save button 312, a cancel button 314, and technical page selectors 316. The partners page is similar in many ways to the technical capabilities page and various differences will be described herein. The technical discipline fields allow a user to input information about the resources and technical qualifications of partners. The agreement fields allow a user to input information about the type of agreement existing with a partner. For example, the organization and partner may be associated by a license agreement, a joint development agreement, a service agreement, etc. The number field, square footage field, location field, and major equipment field allow a user to input information about facilities owned or operated by a partner of an organization. In the depicted embodiment, a user may input information about test facilities, R&D facilities, or service facilities of the partners. The user may also input information about the intellectal property owned by a partner.

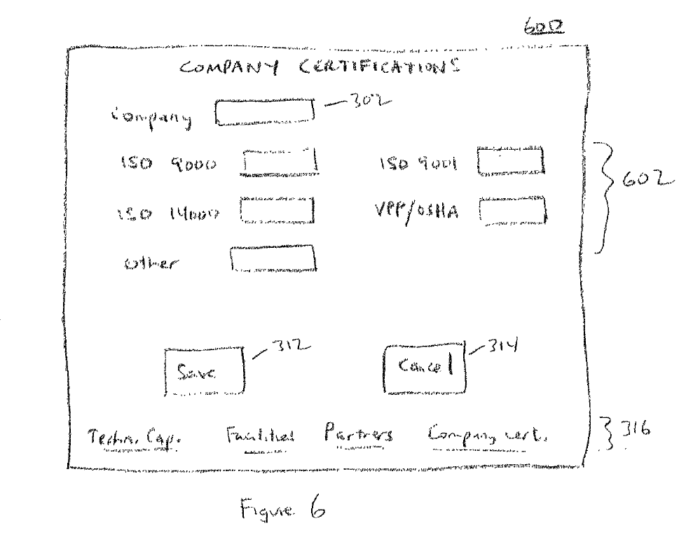

FIG. 6 is a display page used to collect information about the certifications of an organization in one embodiment. Certifications page 600 may be activated when a user selects the certification button of the asset input page or company certifications on the technical page selector. The certification page 600 includes, in the depicted embodiment, a company field 302, certification fields 602, a save button 312, a cancel button 314, and technical page selectors 316. The certifications page is similar in many ways to the technical capabilities page and various differences will be described herein. The certification fields allow a user to input information about any certifications that an organization has achieved or received. Example certifications include ISO 9000, ISO 9001, ISO 14000, VPP/OSHA, etc.

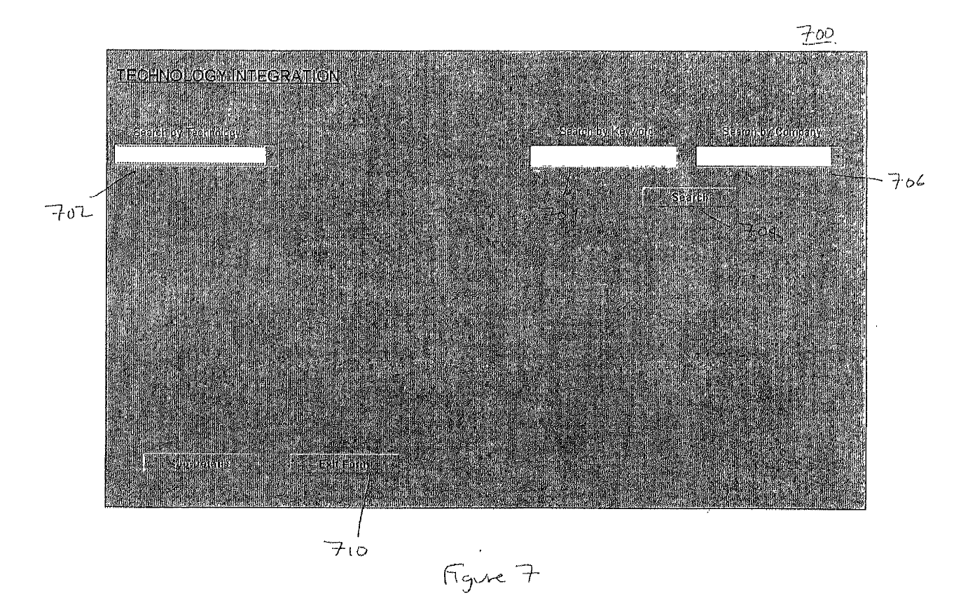

FIG. 7 is a display page used to search for information or potential synergies throughout a group of organizations in one embodiment. Search page 700 may be activated by a user selecting the search button on the main display page. Search page 700 includes a technology search field 702, a keyword search field 704, a company search field 706, a search activation button 708, and an exit form button 710. A search is begun by a user entering data into one or more of the technology search, keyword search, or company search fields and then selecting the search activation button. The technology search field is a pull-down list that includes a list of technologies available within the synergy evaluation system. For example, selecting chemical engineering/emissions would conduct a search for assets within all of the organizations within the system that involve chemical engineering/emissions technology, such as employees with the appropriate background, related facilities, etc. Similarly, the keyword search field allows a user to input one or more keywords (where multiple keywords could be combined with Boolean operators) for searching within the synergy evaluation system. After the search is initiated, the synergy evaluation system will find all instances of that keyword throughout all of the organizations. For example, a user desiring to know where a vacuum chamber exists could enter ‘vacuum chamber’ in the keyword search field and would receive a list of all entries containing the phrase. The company search field is a pull-down list that includes a list of all organizations for which data has been entered. This would allow, for example, a user to determine all of the inputted information for a particular company, such as a new acquisition. In one alternative embodiment, the functionality of the different search fields could be combined, such as by a user selecting an organization and a keyword simultaneously, to further refine the search. The exit form button simply returns the user to the main display page without performing a search.

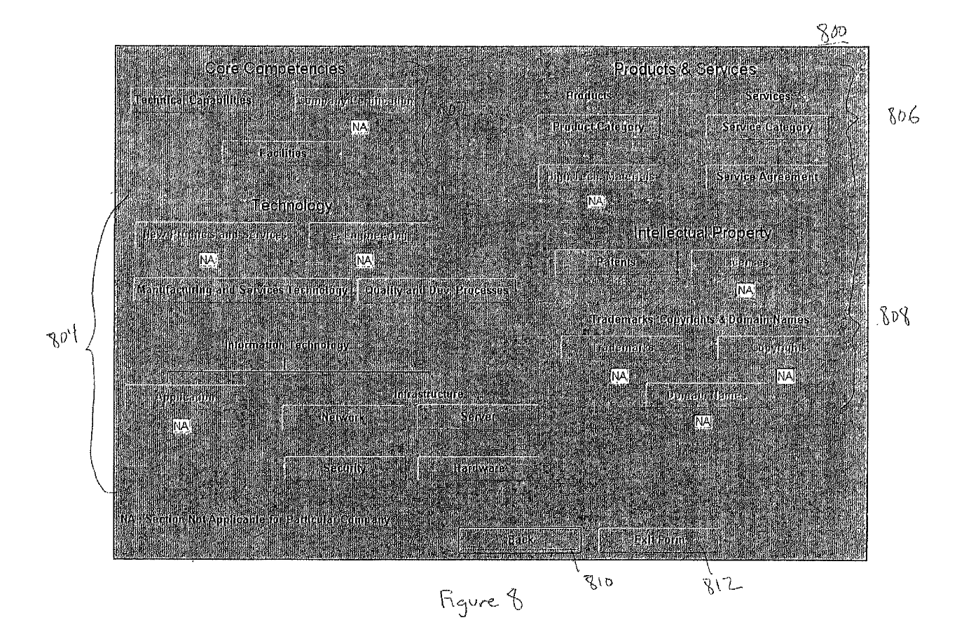

FIG. 8 is a display page illustrating the results of a company search in one embodiment. Company search results page 800 may be created when a user selects a search by company (using the company search field) on the search page. The company search results page 800 includes, in the depicted embodiment, a core competency region 802, a technology region 804, a products & services region 806, an intellectual property region 808, a back button 810, and an exit form button 812. Each region includes information about the company that has been entered into the synergy evaluation system. The core competency region includes a number of buttons, each of which includes more information about a particular area. For example, the core competency region in the depicted embodiment includes a technical capabilities button, a company certification button, and a facilities button. The company certification button, as an example, would activate a display page containing information about any company certifications that an organization would have, the facilities button would activate a display page containing information about facilities owned by the organization, etc. A button may be ‘grayed out’ and labeled with ‘NA’ if no information is available for that subject, such as for company certifications in the depicted embodiment. The company search results page may be useful to get an overview of an organization's assets, such as when an employee may wish to see the assets of a new acquisition.

The technology region is similar to the core competencies region, except that it contains buttons for new products & services, e-Engineering, manufacturing and services technology, quality and dev. processes, information technology applications, and information technology infrastructure. Similarly, the products & services region contains buttons for products, services, high tech materials, and service agreements. The intellectual property region contains buttons for patents, licenses, trademarks, copyrights, and domain names. The back button will return a user to the search page, and the exit form button will exit the application.

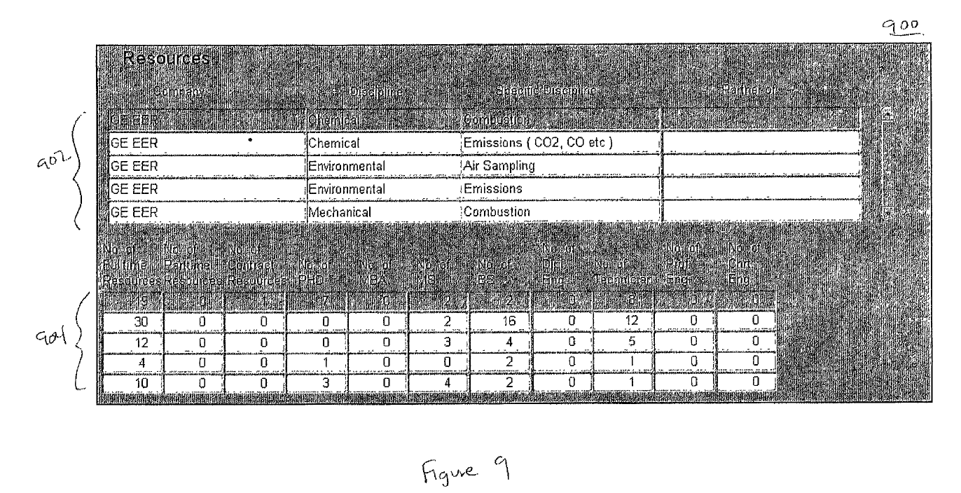

FIG. 9 is a display page depicting a report summarizing the technical capabilities of an organization in one embodiment. Technical capabilities report page 900 may be created when a user selects the technical capabilities button in the core competencies region of the company search results page. The technical capabilities report page includes, in the depicted embodiment, a discipline region 902 and a discipline summary region 904. The discipline region includes a series of rows indicating the organization, discipline, specific discipline, and any partner association for each combination of discipline and specific discipline. The discipline summary region includes a series of rows indicating the breakdown o employees and contractors for each combination of discipline and specific discipline. For example, the highlighted row indicates that there are 19 full time resources and contract resources, with a breakdown of seven PhD's, two MS's, two BS's, and eight technicians. In the depicted embodiment, the highlighted line of the discipline region (chemical/combustion) corresponds to the highlighted line of the discipline summary region described above.

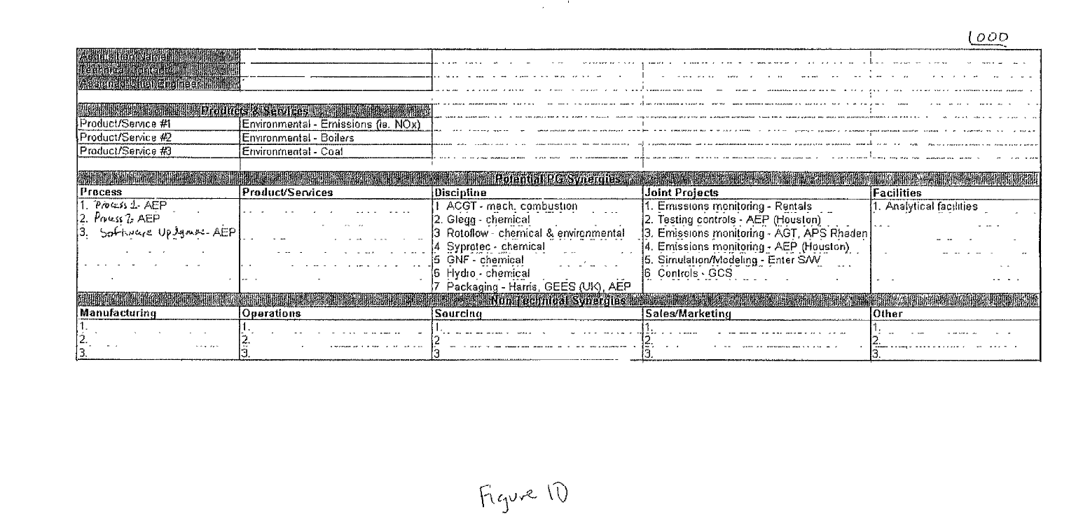

FIG. 10 is a display page depicting a report summarizing the potential synergies of a newly acquired organization with the existing organizations in one embodiment. Potential synergy report page 1000 may be created by an automatic report generation function or by a user requesting a custom report. The potential synergy report page includes a list of potential synergies between a particular organization, such as a newly acquired company, and other organizations under the same corporate structure. For example, when a new company is acquired, a potential synergy report page could be created detailing potential synergies with existing divisions of the acquiring company. The potential synergy report page includes, in the depicted embodiment, a list of products and services and a list of potential synergies. The list of products and services lists the products and services associated with the company (e.g., environmental—emissions, environmental—boilers, etc.). The list of potential synergies is divided into a number of columns, each column listing potential synergies in a particular area. For example, under the ‘discipline’ column the list of potential synergies includes mechanical combustion (with an organization called ACGT), chemical (with organizations called Glegg, Rotoflow, Syprotec, GNF, and Hydro), etc. The potential synergy report page would be particularly useful when an organization is first acquired, so that a manager of that organization could review the report page and search for synergies with other organizations that make business sense to pursue.

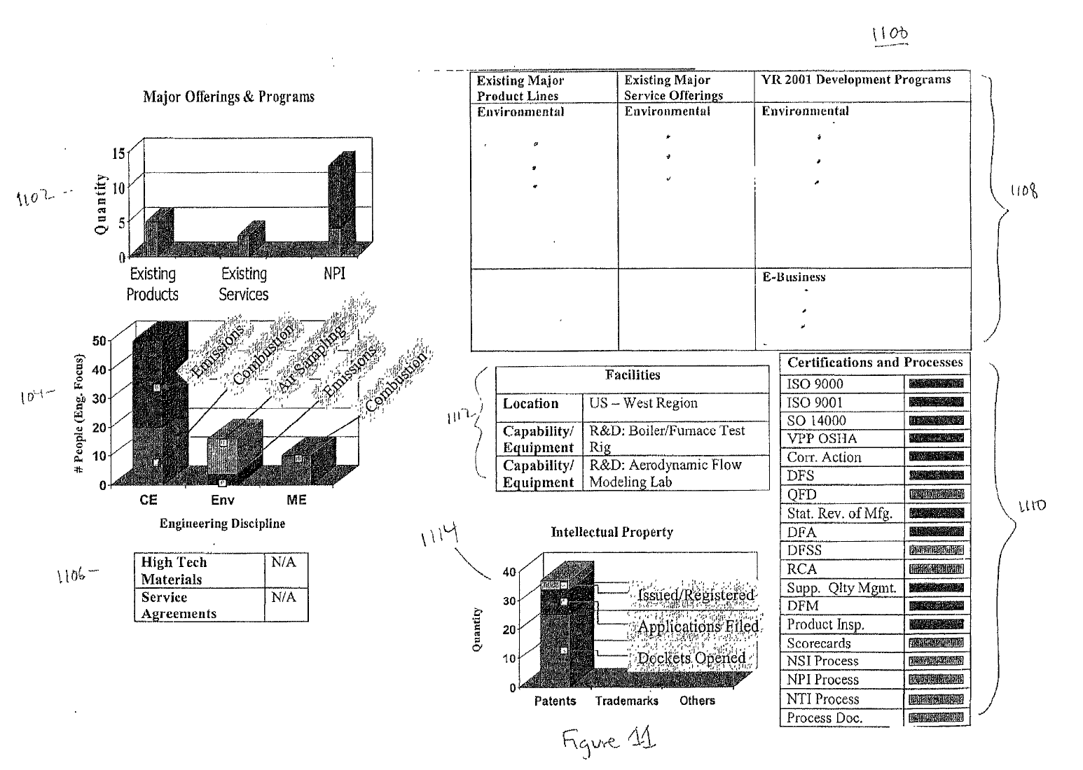

FIG. 11 is a display page depicting a report summarizing the assets of an organization in one embodiment. Asset summary report page 1100 may be created by an automatic report generation function or by a user requesting a custom report. The potential synergy report page includes, in the depicted embodiment, a major offerings chart 1102, a technical resources chart 1104, an other resources chart 1106, a major offerings detail chart 1108, a certifications chart 1110, a facilities chart 1112, and an intellectual property chart 1114. The major offering chart includes a pictorial chart that depicts the number of existing products, existing services, and new product initiatives for the organization. The technical resources chart includes a pictorial chart that depicts the number of technical personnel working in particular disciplines within the organization. In the depicted embodiment, for example, the organization includes 50 chemical engineers (including 20 specializing in combustion and 30 in emissions), 20 environmental engineers, etc. The other resources chart includes a pictorial depiction of other resources owned by the organization, such as high tech materials, service agreements, etc. The major offerings detail chart includes lists of the existing major product lines, existing major service offerings, development programs, e-business programs, etc. The listings of the major offerings detail chart may be summarized by the major offering chart described above. The certifications chart includes a pictorial depiction of certifications received or achieved by the organization (e.g., ISO 9000, ISO 9001, etc.). The facilities chart includes a list of facilities owned by an organization and any special capabilities, specialized equipment, etc., associated with those facilities. The intellectual property chart includes a pictorial depiction of the intellectual property owned by the organization, such as patents, trademarks, copyrights, etc. The status of the intellectual property is also shown, such as docket opened, application filed, patent issued, trademark registered, etc.

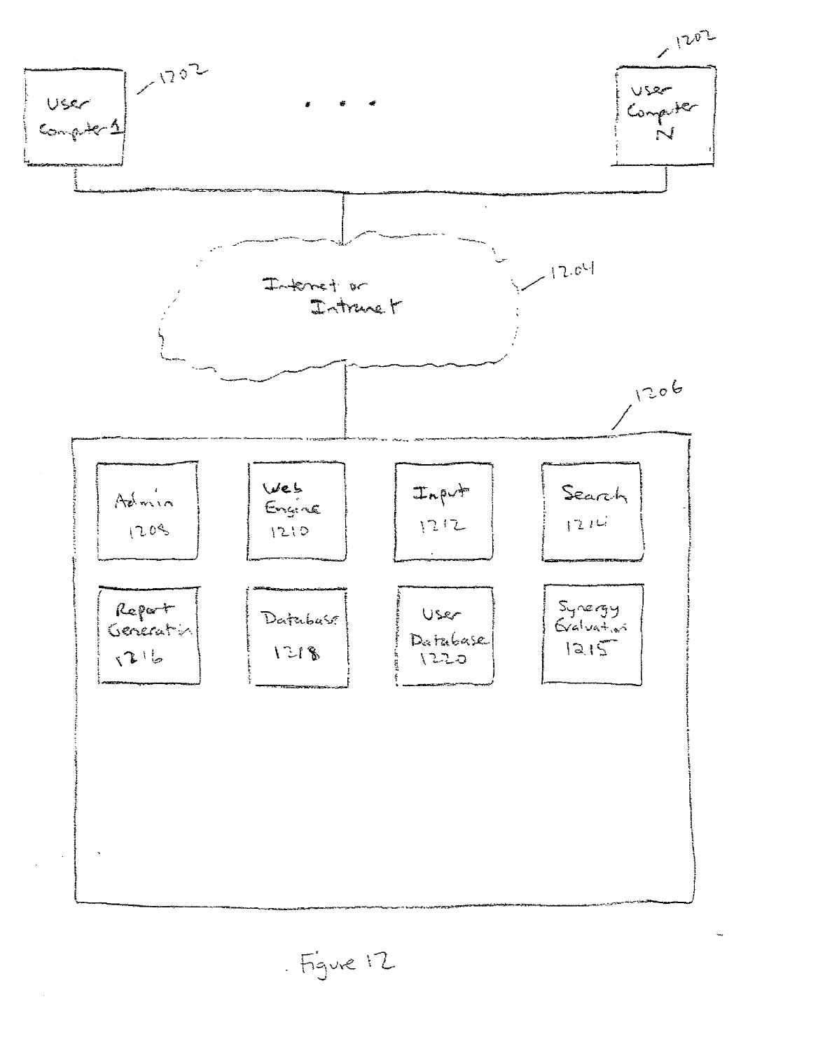

FIG. 12 is a block diagram that illustrates components of the synergy evaluation system and user computers in one embodiment. The synergy evaluation server 1206 and one or more user computers 1202 are interconnected via a computer network 1204, such as the Internet or an intranet. The computers may include a central processing unit, memory, input devices (e.g., keyboard and pointing device), output devices (e.g., display devices), and storage devices (e.g., a hard drive, a CD-ROM, a floppy disk drive, etc.). In addition, the data structures and message structures may be stored or transmitted via a data transmission medium, such as a signal on a communications link. Various communications channels may be used, such as a local area network, wide area network, or a point-to-point dial-up connection. One skilled in the art will appreciate that the synergy evaluation system can be implemented in other environments such as a client/server environment in which the synergy evaluation software executes on a client computer and accesses a database on a server computer that stores the synergy evaluation and/or organization data.

The synergy evaluation server includes an admin component 1208, a web engine 1210, an input component 1212, a search component 1214, a synergy evaluation component 1215, a report generation component 1216, an organization database 1218, and a user database 1220. The admin component allows an administrator to perform administrative tasks such as adding or deleting users, modifying data in the database, or defining permissions. The web engine receives requests, such as HTTP requests, from user computers and invokes the appropriate component of the synergy evaluation system to service any requests and to provide responses, such as HTTP responses. The input component coordinates the entry of the search requests, organizational data, etc. The organization database is used to store the organization data, including the details about the organization, description of the organization's assets, etc. The organization database may be located within the synergy evaluation server, or may be alternatively in communication with the synergy evaluation search server. The search component searches the organization database for synergy data, such as organizational assets, based on the input received by the input component. The synergy evaluation component evaluates and/or compiles the data found by the search component to assist in the determination of potential synergies, while the report generation component creates a report based on the results for the synergy evaluation component and the search component. The user database may contain an entry for each user authorized to use the synergy evaluation system. The user database may include a user name and password of each user for authentication and authorization purposes. Each user may have different levels of authority. For example, one user may have authority to only search for synergies, while another user (e.g., an administrator) may have authority to modify the database (e.g., add new organizations to the system).

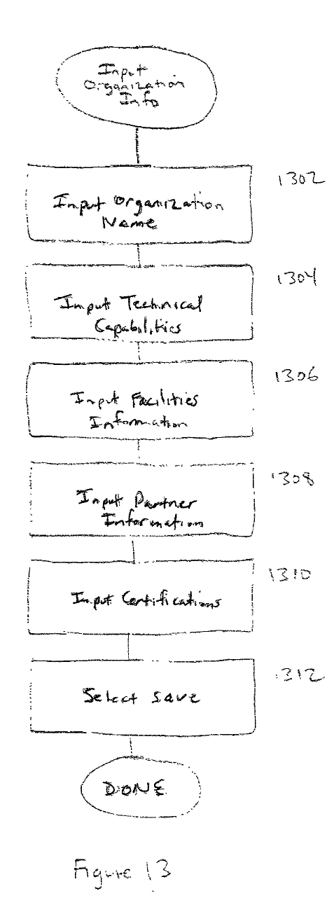

FIGS. 13-18 are flow diagrams illustrating processing of the synergy evaluation system in one embodiment. FIG. 13a is flow diagram illustrating input of organizational data by a user in one embodiment. A user may input organization data when an organization is acquired, via either an acquisition or merger, or when new data is available (such as when new assets are acquired). In block 1302, the user inputs the organization name, such as by using the company field. In block 1304, the user inputs technical capabilities, such as by using the technical capabilities page described in relation to FIG. 3. In block 1306, the user inputs facilities information, such as by using the facilities page described in relation to FIG. 4. In block 1308, the user inputs partner information, such as by using the partners page described in relation to FIG. 5. In block 1310, the user inputs certification information, such as by using the certifications page described in relation to FIG. 6. The function continues in block 1312, where the user may choose the information that has been entered by selecting a save button and the function completes.

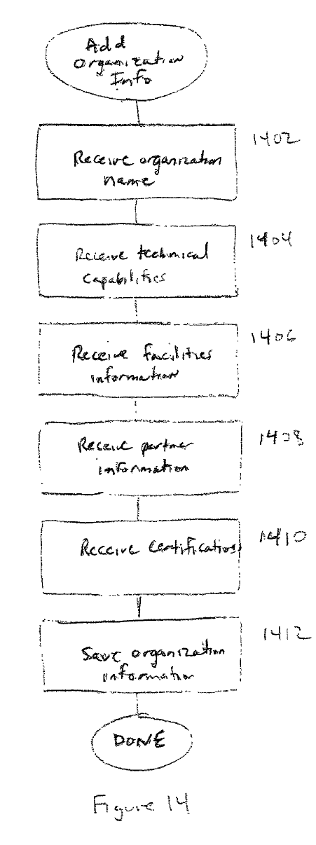

FIG. 14 is a flow diagram illustrating the receipt of organizational data by the synergy evaluation system in one embodiment. The synergy evaluation system may receive organizational data from the input of a user, as described in relation to FIG. 14, or from an automated process. In block 1402, the function receives the organization name and in block 1404, the function receives technical capabilities. In block 1406 the function receives facilities information, in block 1408 the function receives partner information, and in block 1410 the function receives certification information. The function continues in block 1412, where the information that has been receives is saved in a database and the function completes.

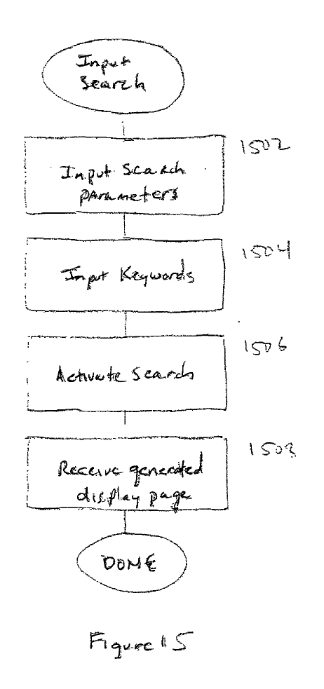

FIG. 15 is a flow diagram illustrating input of a search request by a user in one embodiment. A user may input a search request when the user desires to find out information about an organization or to determine potential synergies. In block 1502, the user inputs search parameters, such as the name of an organization or a technology. In one embodiment, the user may input this information via the company search field or the technology search field. In block 1504, the user may input a keyword to refine the search. For example, the user may input a keyword such as “air tunnel” in the keyword search field to limit the search to entries that include “air tunnel.” One skilled in the art will recognize that combinations of these search choices are possible and within the scope of the invention, such as searching by keyword only, keyword and organization, organization and technology, keyword and technology, etc. In block 1406, the user activates the search, such as by selecting a search button. In block 1408, the user receives a generated display page with the results of the search and the function completes.

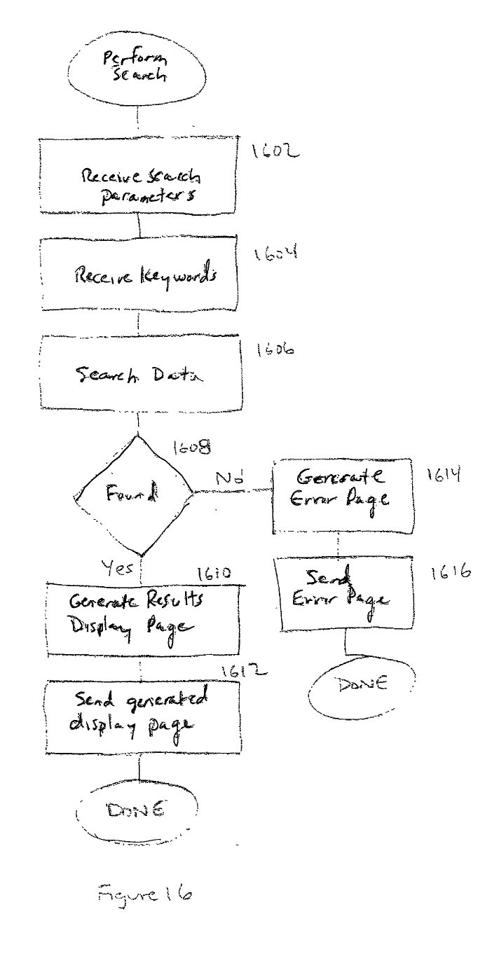

FIG. 16 is a flow diagram illustrating the receipt of a search request by the synergy evaluation system in one embodiment. The function may receive a search request when a user requests a search, such as described in relation to FIG. 15. In block 1602, the function may receive search parameters, such as the name of an organization or a technology. In block 1604, the function may receive a keyword to refine the search. The function may receive any combination of search parameters and keyword. In block 1606, the function searches the database based on the search parameters and/or keywords received. In decision block 1608, the function determines if any results were found from the search. If results were found, the function continues in block 1610, where the function generates a results display page or other embodiment of the search results. In block 1612, the generated results display page is transmitted to the user on a user computer and the function completes. If search results are not found, the function continues to block 1614, where the function generates an error page. In block 1616, the error page is transmitted to the user on a user computer and the function completes.

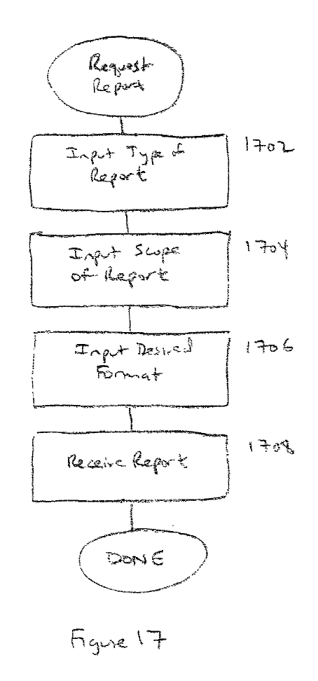

FIG. 17 is a flow diagram illustrating input of a report request by a user in one embodiment. A user may input a report request when the user desires to have a report created that details potential synergies or provides a summary of information about an organization. In block 1702, the user inputs information about the type of report desired, such as a synergy summary, organization summary, etc. In block 1704, the user may input restrictions or details on the scope of the search, such as time requirements, geographic limits, level of detail of the report, etc. In block 1706, the user may input a desired format for the report, such as delivery method, size of the report, etc. In block 1708, the user receives the completed report, such as by a generated display page that includes the report, and the function completes.

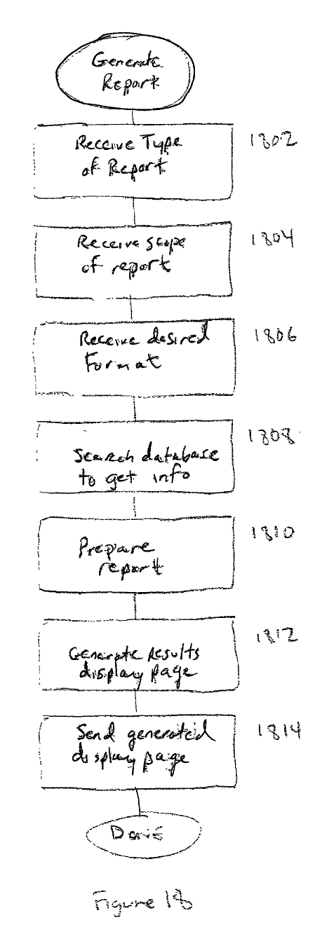

FIG. 18 is a flow diagram illustrating the receipt of a report request by the synergy evaluation system in one embodiment. The function may receive a report request from a user or the reports may be automatically generated at particular time intervals, upon the occurrence of certain events, or upon request. In block 1802, the function receives information about the type of report desired, such as a synergy summary, organization summary, etc. In block 1804, the function receives input restrictions or details on the scope of the search, such as time requirements, geographic limits, level of detail of the report, etc. In block 1806, the function receives a desired format for the report, such as delivery method, size of the report, etc. In block 1808, the function searches the database to gather the information necessary to create the report. The function continues in block 1810, where the function prepares a report based on the received report parameters and the information found in the search. The function continues in block 1812, where the function generates a report display page or other embodiment of the report. In block 1814, the generated report display page is transmitted to the user on a user computer and the function completes.

From the above description, it will be appreciated that although specific embodiments of the synergy evaluation system have been described for purposes of illustration, various modifications may be made without deviating from the scope of the invention. Accordingly, the invention is not limited except by the following claims.

1. A synergy evaluation system comprising:
an input component for receiving organizational information about an organization, the organizational information including information about the assets of the organization;
a organization database for storing the organizational information for a plurality of organizations;
a search component for searching the database for organization information of organizations, the search being based on search parameters specified by a user; and
a synergy evaluation component for evaluating the organization information found in the search conducted by the search component, wherein the synergy evaluation component identifies a potential synergy between two organizations.

2. The synergy evaluation system of claim 1 further comprising a report generation component for creating a report based on search results, the report including information about the organizations and the potential synergy between two organizations.

3. The synergy evaluation system of claim 1 wherein the input component receives the search parameters from a user.

4. The synergy evaluation system of claim 1 further comprising a report generation component for creating a report based on search results, the report including information about organizations and potential synergy between two organizations, wherein the report is based on report parameters received by the input component from a user.

5. The synergy evaluation system of claim 1 wherein the organizational information includes information about intellectual property owned by an organization.

6. The synergy evaluation system of claim 1 wherein the organizational information includes information about facilities owned by an organization.

7. The synergy evaluation system of claim 1 wherein the organizational information includes information about technical resources associated with an organization.

8. The synergy evaluation system of claim 1 wherein the organizational information includes information about partnerships of an organization.

9. The synergy evaluation system of claim 1 wherein the organizational information includes information about assets of an organization.

10. The synergy evaluation system of claim 1 wherein the information about the plurality of organizations includes information about certifications associated with an organization.

11. A method in a computer system for evaluating synergies between multiple organizations, the method comprising:
receiving organizational information about an organization, the organizational information including information about the assets of the organization;
storing the organizational information for a plurality of organizations;
searching the stored organization information;
evaluating the organizational information found in the search; and
identifying potential synergy between two organizations based on the evaluation of the organizational information.

12. The method of claim 11 further comprising generating a report, the report including an indication of the identified potential synergy between two organizations.

13. The method of claim 11 further comprising receiving search parameters from a user.

14. The method of claim 11 further comprising receiving report parameters from a user.

15. A computer-readable medium whose contents cause a computer to search for potential synergy related to multiple organization by a method comprising:
receiving organizational information about an organization, the organizational information including information about the assets of the organization;
storing the organizational information for a plurality of organizations;
searching the stored organizational information;
evaluating the organizational information found in the search; and
identifying potential synergy between two organizations based on the evaluation of the organizational information.

16. The computer-readable medium of claim 15 further comprising generating a report, the report including an indication of the identified potential synergy between two organizations.

17. The computer-readable medium of claim 15 further comprising receiving search parameters from a user.

18. The computer-readable medium of claim 15 further comprising receiving report parameters from a user.

19. A synergy evaluation system comprising:
a receiving means for receiving organizational information about an organization, the organizational information including information about the assets of the organization;
a storing means for storing the organizational information for a plurality of organizations;
a searching means for searching the database for organization information of organizations, the search being based on search parameters specified by a user;
a synergy evaluation means for evaluating the organizational information found in the search conducted by the search component; and
a results means for identifying potential synergy between two organizations.

20. A computer-readable medium containing a data structure for use by a synergy evaluation system, the data structure comprising:
an indication of organizational information for a first organization, the organizational information including information about assets of the first organization; and
an indication of organizational information for a second organization, the organizational information including information about assets of the second organization.

21. The computer-readable medium of claim 20 further comprising an indication of potential synergy between the first organization and the second organization.

22. A method in a computer system for evaluating synergies between multiple organizations, the method comprising:
inputting search parameters, wherein the search parameters include information about a desired search, wherein further the search parameters include at least one of an organization name, a keyword, or of a technology;
requesting the desired search;
transmitting the search parameters to a synergy evaluation server; and
receiving search results from the synergy evaluation server.

23. The method of claim 22 wherein the search results include an indication of a potential synergy between two organizations to a user.

24. The method of claim 22 wherein the search results include information about the assets of an organization.

25. A synergy evaluation system on a user computer comprising:
an input component for receiving search parameters, wherein the search parameters include information about a desired search, wherein further the search parameters include at least one of an organization name, a keyword, or of a technology;
a transmission component for transmitting the search parameters to a synergy evaluation server;
a receiving component for receiving search results from the synergy evaluation server; and
a display component for displayling the search results to a user.

26. The synergy evaluation system of claim 25 wherein the search results include an indication of a potential synergy between two organizations to a user.

27. The synergy evaluation system of claim 25 wherein the search results include information about the assets of an organization.
